(19) United States
(12) Patent Application Publication
(10) Pub. No.: US 2003/0036619 A1
(43) Pub. Date: Feb. 20, 2003

(54) Method for optimizing material transformation

(76) Inventors: Ray W. Chrisman, Midland, MI (US); Larry D. Kershner, Midland, MI (US); Daniel A. Hickman, Midland, MI (US); Mark E. Jones, Midland, MI (US); Duane R. Romer, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/206,022

(22) Filed: Jul. 26, 2002

Related U.S. Application Data
(60) Provisional application No. 60/307,997, filed on Jul. 26, 2001.

(51) Int. Cl. C08F 110/14; G06F 19/00; G01N 31/00

(52) U.S. Cl. 526/348.2; 702/22

(57) ABSTRACT

The instant invention is a method for optimizing material transformation that includes the following six steps. The first step is to identify at least one physical variable that affects performance of a continuous unit operation for the material transformation. The second step is to select an initial set point of the at least one physical variable. The third step is to continuously perform the unit operation to produce a transformed material. The fourth step is to analyze the product to determine at least one component of interest of the transformed material. The fifth step is to select a subsequent set point of the at least one physical variable based on the analysis of the fourth step. The last step is to repeat steps three to five a sufficient number of times to optimize the unit operation.

### CROSS REFERENCE TO RELATED APPLICATION

This application claims the benefit of U.S. Provisional Application, Serial No. 60/307,997, filed Jul. 26, 2001.

### FIELD OF THE INVENTION

The instant invention is in the field of methods for optimizing material transformations, such as optimizing a chemical reaction or the crystallization of a material. More specifically, the instant invention relates to optimizing a continuous unit operation for material transformations.

### BACKGROUND OF THE INVENTION

Research and development of new and better materials and more efficient processes for making such materials may or may not be profitable. In an increasingly competitive commercial environment it would be an advance if better methods were developed to optimize the processes used to make such materials. U.S. Pat. Nos. 5,463,564 5,574,656 and 5,684,711 (herein fully incorporated by reference) describe a computer based, iterative process for generating chemical entities with defined properties. U.S. Pat. No. 6,044,212 (herein fully incorporated by reference) describes a method for optimizing chemical reactions of the batch type. However, the use of batch reactors, including the multiple well batch reactors described in the U.S. Pat. No. 6,044,212, for such research and development projects poses a number of serious problems. Batch reactors are difficult to automate and difficult to clean so that they can be used again without contamination. In addition, it is difficult to scale-up the results from a small batch reactor to a much larger production reactor because of the very much different mass transfer, heat transfer and mixing characteristics of a small batch reactor in relation to a larger production reactor.

### SUMMARY OF THE INVENTION

The instant invention is a solution, at least in part, to the problems of the use of batch reactors for automated research and development of new and better materials. The instant invention is a method for optimizing material transformation using a continuous unit operation, the method comprising six steps. The first step is to identify at least one physical variable that affects performance of a continuous unit operation for the material transformation. The second step is to select an initial set point of the at least one physical variable. The third step is to continuously perform the unit operation to produce a transformed material. The fourth step is to analyze the transformed material to determine at least one component of interest of the transformed material. The fifth step is to select a subsequent set point of the at least one physical variable based on the analysis of the fourth step. The last step is to repeat steps three to five a sufficient number of times to optimize the unit operation.

### BRIEF DESCRIPTION OF THE DRAWINGS

FIG. 1 shows a schematic view of an apparatus that can be used in the instant invention that includes a tube reactor and a size exclusion chromatography system.

### DETAILED DESCRIPTION OF THE INVENTION

The instant invention is a method for optimizing material transformation comprising six steps. The first step is to identify at least one physical variable that affects performance of a continuous unit operation for the material transformation. The second step is to select an initial set of the at least one physical variable. The third step is to perform the unit operation to produce a transformed material. The fourth step is to analyze the transformed material to determine at least one component of interest of the transformed material. The fifth step is to select a subsequent set of the at least one physical variable based on the analysis of the fourth step. The last step is to repeat steps three to five a sufficient number of times to optimize the unit operation.

For example, an initial temperature is selected as the set point for a continuous polymerization reaction. A general purpose digital computer is used to select a subsequent temperature for the reaction based on an analysis of the product from the reaction and an optimization strategy programmed into the computer. The steps are repeated to optimize the temperature set point of the reaction. The instant invention can be used for any purpose including, without limitation, research, development or production.

The term “material transformation” means, without limitation, chemical reaction (including catalyzed chemical reactions such as catalyzed chemical reactions that employ a heterogeneous or a homogeneous catalyst system), crystallization, distillation, extraction, mixing and separation. The term “optimizing material transformation” means to find the best (or at least better) physical variables for a material transformation using a given set of criteria. For example, it may be desired to optimize the yield, rate and co-product formation of a chemical reaction by increasing the yield and rate of the reaction while decreasing the co-product formation. The term “continuous unit operation” means a unit operation that is fed at least one material, at least at some time, during the operation. Most preferably, a continuous unit operation is a unit operation that is fed at least one material without interruption during the operation, and includes, without limitation, any continuous reaction or other unit operation including tubular reactors, mixed flow reactors, fluidized bed reactors, trickle bed reactors, crystallizers, distillation towers, extractors, mixers and separators. The term “analyzing” includes any form of chromatography, any form of spectroscopy, any form of thermal analysis and more generally any of the techniques used in the art of chemical or material analysis. In its broadest scope, the term “analyzing the transformed material to determine at least one component of interest of the transformed material” includes the determination of at least one physical property such as refractive index, viscosity, density, electrical conductivity, dielectric constant, temperature or pressure and/or identifying a component of interest and its concentration. The specific analyzer is usually selected based on the known analytical methods.

Most preferably the instant invention is practiced with regard to catalysts for two or more reactants such as the catalytic polymerization of “polyethylene” from ethylene and octene. When using the instant invention for catalyst studies, the instant invention provides the advantage over the prior art of studying catalyst(s) and reactant(s) using a system that provides a better understanding of the reaction, that is faster, that is easier to automate and that is less subject to contamination. A primary benefit of the instant invention over the prior art batch reactors is a better understanding of the kinetics of the reaction.

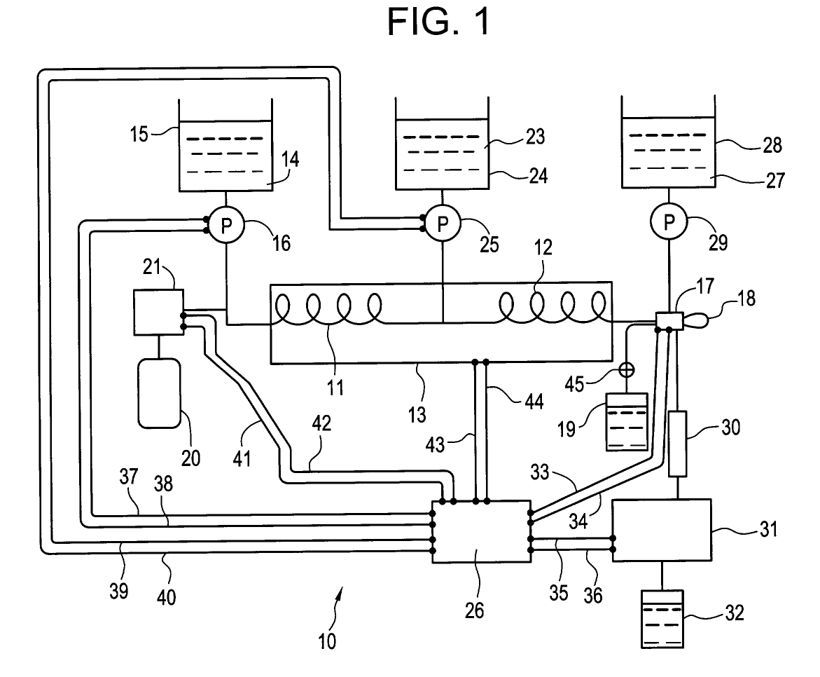

Referring now to FIG. 1, therein is shown a schematic view of an apparatus embodiment 10 that can be used in the instant invention. The apparatus 10 includes a five foot long section of 1/16 inch stainless steel tubing pre-heater 11 and a ten foot long section of 1/16 inch stainless steel tubing as a tube reactor 12. The pre-heater 11 and tube reactor 12 are enclosed in a temperature controlled oven 13. Isooctane solvent 14 contained in solvent reservoir 15 is pumped by a first controllable metering pump 16 through the pre-heater 11, the tube reactor 12, then through an electrically actuated automatic High Performance Liquid Chromatography (HPLC) rotary injection valve 17 equipped with an injection loop 18, through a back-pressure regulator 45 and then to a reactor waste reservoir 19.

The apparatus 10 also includes a source of ethylene 20. The ethylene is flowed under pressure into the stream of solvent 14 flowing into the tube reactor 12 by way of an electrically controlled flow controller 21. A dispersion of metallocene polymerization catalyst in isooctane 23 contained in catalyst reservoir 24 is pumped by a second controllable metering pump 25 into the stream of solvent 14 and ethylene flowing into the tube reactor 12. At least a portion of the ethylene flowing into the tube reactor 12 catalytically polymerizes in the tube reactor 12 to form a polyethylene solution that flows through the loop 18.

The apparatus 10 also includes dichlorobenzene eluant 27 contained in eluant reservoir 28. The eluant 27 is pumped by HPLC pump 29 through the injection valve 17, through the Size Exclusion Chromatography (SEC) column 30, through the refractive index detector 31 and then to a waste eluant reservoir 32. The SEC system is contained in an oven, not shown, as is typical for the SEC analysis of polyethylene. The apparatus 10 also includes a general purpose digital computer 26. Periodically, the computer 26 sends a signal via wires 33 and 34 to the injection valve 17 so that the polymer solution in the injection loop 18 is injected into the SEC column 30. The refractive index detector 31 is in electrical communication with the computer 26 via wires 35 and 36 so that the computer 26 can determine the amount and molecular weight distribution of the polymer produced in the tube reactor 12.

The first and second controllable metering pumps 16 and 25, and the flow controller 21 are in electrical communication with the computer 26 via wires 37-42 so that the computer 26 can control the flow rate of solvent 14, the flow rate of catalyst solution 23 and the flow rate of ethylene flowed through the tube reactor 12. In addition, the computer 26 is in electrical communication with the oven 13 via wires 43 and 44 so that the computer 26 can control the temperature of the pre-heater 11 and the tube reactor 12.

The physical variables that affect the performance of the system shown in FIG. 1 include the flow rates of the solvent 14, the ethylene 20 and the catalyst solution 23 as well as the temperature of the tube reactor 12. The computer 26 is manually set for the initial flow rates of the solvent 14, the monomer solution 20 and the catalyst solution 23 as well as the temperature of the tube reactor 12. Following the first SEC analysis of the polymer produced by the initial physical variables, the computer is programmed to automatically select a subsequent second set of physical variables based on the first SEC analysis. Following the second SEC analysis of the polymer produced by the second physical variables, the computer is programmed to automatically select a subsequent third set of physical variables based on the second SEC analysis. This process is repeated to optimize the system. The specific optimization program selected for the computer 26 is not critical in the instant invention and include, of course, all of the optimization programs well known in the prior art such as simplex optimization. Simplex optimization software for general purpose digital computers is commercially available, for example, as MultiSimplex brand software from Statistical Designs of Huston, Tex.

Referring still to FIG. 1, the pump 25 can alternatively be momentarily actuated to produce a “peak” of polyethylene in the tube reactor 12 (in contrast, in the discussion above a “square wave” of polyethylene is produced in the tube 12). When the apparatus 10 is used in this manner, the computer 26 is programmed to send a signal via wires 33 and 34 to the injection valve 17 when the polymer solution “peak” or portion thereof is in the injection loop 18 so that polymer solution is injected into the SEC column 30. The physical variables that affect the performance of such an alternative system include the flow rates of solvent 14 and ethylene 20, the length of time the pump 25 is turned on (and thus the amount of catalyst solution that is introduced into the tube reactor 12) as well as the temperature of the tube reactor 12. The computer 26 is manually set for the initial flow rates of the monomer 20 and solvent 14, the length of time the pump 25 is turned on as well as the temperature of the tube reactor 12. Following the first SEC analysis of the polymer produced by the initial physical variables, the computer is programmed to automatically select a subsequent second set of physical variables based on the first SEC analysis. Following the second SEC analysis of the polymer produced by the second physical variables, the computer is programmed to automatically select a subsequent third set of physical variables based on the second SEC analysis. The process is repeated to optimize the system.

### EXAMPLE 1

The system shown in FIG. 1 is constructed as discussed above. The pumps 16/25 and flow controller 21 are originally set so that the plug flow residence time in the tube reactor 12 is five seconds with a constant input concentration of ethylene and catalyst. The system is run continuously for one minute and then the valve 17 is rotated to its inject position. Analysis of the polyethylene produced shows the fraction of the ethylene converted to polyethylene. The computer 26 is programmed with a kinetic model that assumes a first order reaction. The pump 16, flow controller 21 and pump 25 are set by the computer 26 so that the plug flow residence time in the tube reactor 12 is ten seconds with all other physical variables the same as before. Analysis of the polyethylene produced shows the fraction of the ethylene converted to polyethylene. The computer 26 compares the fraction of the ethylene converted to polyethylene with the fraction predicted by the model. The computer 26 then sets the pump 16, flow controller 21 and pump 25 so that the plug flow residence time in the tube reactor 12 is twenty seconds with all other physical variables the same as before. Analysis of the polyethylene produced shows the fraction of the ethylene converted to polyethylene. The computer 26 compares the fraction of the ethylene converted to polyethylene with the fraction predicted by the model for the various runs.

The computer 26 increases the temperature of the oven 13 by five degrees Celsius from its original temperature and then the above three runs are repeated. The computer 26 increases the temperature of the oven 13 by ten degrees Celsius from its original temperature and then the above three runs are repeated. The computer 26 compares the fraction of the ethylene converted to polyethylene with the fraction predicated by the model for the various runs.

The computer 26 returns the oven 13 to its original temperature and instead increases the flow rate of the pump 25 to increase the concentration of catalyst in the tube reactor 12 with a corresponding adjustment of the pump 16 and the flow controller 21 so that the concentration of ethylene flowing into the tube reactor 12 remains the same with a plug flow residence time in the tube reactor 12 of five seconds. Analysis of the polyethylene produced shows the fraction of the ethylene converted to polyethylene. The pump 16, flow controller 21 and pump 25 are set by the computer 26 so that the plug flow residence time in the tube reactor 12 is ten seconds with all other physical variables the same as before. Analysis of the polyethylene produced shows the fraction of the ethylene converted to polyethylene. The pump 16, flow controller 21 and pump 25 are set by the computer 26 so that the plug flow residence time in the tube reactor 12 is twenty seconds with all other physical variables the same as before. Analysis of the polyethylene produced shows the fraction of the ethylene converted to polyethylene. The computer 26 compares the fraction of the ethylene converted to polyethylene with the fraction predicated by the model for the various runs.

The computer 26 adjusts the flow controller 21, and the pumps 16 and 25 so that the concentration of catalyst entering the tube reactor 12 is returned to its original concentration but the concentration of ethylene entering the tube reactor 12 is doubled. The plug flow residence time in the tube reactor 12 is five seconds. Analysis of the polyethylene produced shows the fraction of the ethylene converted to polyethylene. The pump 16, flow controller 21 and pump 25 are set by the computer 26 so that the plug flow residence time in the tube reactor 12 is ten seconds with all other physical variables the same as before. Analysis of the polyethylene produced shows the fraction of the ethylene converted to polyethylene. The computer 26 compares the fraction of the ethylene converted to polyethylene with the fraction predicted by the model. The computer 26 then sets the pump 16, flow controller 21 and pump 25 so that the plug flow residence time in the tube reactor 12 is twenty seconds with all other physical variables the same as before. Analysis of the polyethylene produced shows the fraction of the ethylene converted to polyethylene. The computer 26 compares the fraction of the ethylene converted to polyethylene with the fraction predicted by the model for the various runs.

The computer now has an extensive data set at various reaction times, temperatures and concentrations of ethylene and catalyst to compare with the predicted data set from the kinetic model so that the computer can formulate a corrected model that more accurately predicts the behavior and kinetics of the reaction such as the activation energy and rate. Repeating the study with a different catalyst provides a comparison of the two catalysts. Repeating the study with a set of catalysts provides a means of finding an optimum catalyst.

### EXAMPLE 2

A system like that shown in FIG. 1 is assembled except that the oven 13 is a controlled chiller set at ten degrees Celsius, the solvent 14 is carbon disulfide, the flow controller 21 controlls the addition if bromine, the solvent 23 is a mixture of phenol and carbon disulfide, the eluant 27 is a reverse phase liquid chromatography eluant, the column 30 is a reverse phase liquid chromatography column and the detector 31 is a variable wavelength liquid chromatography detector. The pumps 16/25 and flow controller 21 are originally set so that the plug flow residence time in the tube reactor 12 is sixty seconds with a constant input concentration of bromine and phenol. The system is run continuously for five minutes and then the valve 17 is rotated to its inject position. The analysis indicates the presence and concentration of unreacted phenol, p-bromomo phenol product and o-bromophenol co-product. The computer 26 is programmed to use simplex optimization. The computer 26 changes the concentrations of phenol, bromine, reaction temperature and reaction time using the simplex optimization program by reiterave steps to optimize the reaction for maximum rate of production of p-bromophenol with at least 99 percent of the phenol being converted to o-bromophenol and p-bromophenol but with no more that ten percent of the phenol being converted to o-bromophenol.

What is claimed is:

1. A method for optimizing material transformation, comprising the steps of:
(a) identifying at least one physical variable that affects performance of a continuous unit operation for the material transformation;
(b) selecting an initial set point of the at least one physical variable;
(c) continuously performing the unit operation to produce a transformed material;
(d) analyzing the transformed material to determine at least one component of interest of the transformed material;
(e) selecting a subsequent set point of the at least one physical variable based on the analysis of step (d);
(f) optimizing the unit operation by repeating steps (c)-(e).

2. The method of claim 1, wherein the continuous unit operation uses a tube reactor.

3. The method of claim 2, wherein the transformed material comprises a polymer.

4. The method of claim 1, wherein the transformed material comprises a polymer produced by catalytic polymerization.

5. The method of claim 4, wherein the polymer comprises a copolymer.

6. The method of claim 5, wherein the copolymer comprises a copolymer of ethylene and an olefin.

7. The method of claim 6, wherein the olefin comprises 1-octene.

8. The method of claim 1, wherein steps (c)-(f) are automated.

9. The method of claim 8, wherein steps (c)-(f) are automated using a general prupose digital computer.
